(19) United States
(12) Patent Application Publication
(10) Pub. No.: US 2025/0248559 A1
(43) Pub. Date: Aug. 7, 2025

(54) A MECHANICALLY OPERATED VALVE

(71) Applicant: Koninklijke Douwe Egberts B.V., Utrecht (NL)

(72) Inventors: Gerbrand Kristiaan de Graaf, Utrecht (NL); Jacobus Petrus Maria Dessing, Nieuw-Vennep (NL); Frans de Graaf, Nieuw-Vennep (NL)

(21) Appl. No.: 18/856,031

(22) PCT Filed: Apr. 11, 2023
(86) PCT No.: PCT/EP2023/059382

§ 371 Date: Oct. 10, 2024

(30) Foreign Application Priority Data
Apr. 13, 2022 (GB) 2205466.2

(51) Int. Cl. A47J 31/44; A47J 31/46; F16K 31/56

(52) U.S. Cl. CPC A47J 31/4485; A47J 31/4489; A47J 31/461; F16K 31/563

(57) ABSTRACT

This disclosure provides a beverage preparation apparatus, comprising: a first fluid delivery line (2); a second fluid delivery line (4); a fluid outlet nozzle (440) which is movable between a stowed position and an operational position and configured to receive fluid from at least the second delivery line (4) when in the operational position; and, a valve arrangement (1) having a valve member (6) movable between a first position in which the first fluid delivery line (2) is open and the second fluid delivery line (4) is shut-off, and a second position in which the first fluid delivery line (2) is shut-off and the second fluid delivery line (4) is open, wherein the valve member (6) is mechanically coupled to the fluid outlet nozzle (440) such that moving the fluid outlet nozzle (440) between the stowed and operational position shifts the valve member (6) between the first and second positions and returning the fluid outlet nozzle (440) to the stowed position shifts the valve member (6) from the second position to the first position.

### TECHNICAL FIELD OF THE INVENTION

The present disclosure relates to a mechanically operated valve for a beverage preparation apparatus. In particular, the valve may be a pinch valve.

### BACKGROUND TO THE INVENTION

Beverage preparation apparatuses which prepare and dispense beverages are well known in the art. Such machines typically include one or more valves for shutting off fluid delivery lines of various types to control the flow of fluids between internal components and/or external components such as an outlet nozzle from which a prepared beverage may be provided.

A common type of valve utilised in beverage preparation apparatuses are so-called pinch valves which rely on the compression of a fluid delivery line for shut off.

U.S. Pat. No. 8,839,711 discloses a beverage preparation machine with a pinch valve configured to alternately shut-off each of two fluid passage lines to provide a changeover valve according to a control function. The valve comprises a drive with a stepper motor which is disclosed as actuating either a linear or a rotatory pinch mechanism.

U.S. Pat. No. 3,517,859 discloses a beverage preparation apparatus having a manually operated changeover pinch valve which is configured to alternate supply of hot water from different urns. The valve comprises a crank operable by a user to alternately swing a roller from one fluid delivery line of a pair of lines to the other to select which urn provides the hot water for brewing.

The present invention seeks to provide an improved valve arrangement.

### SUMMARY OF THE INVENTION

The present invention provides a beverage dispensing apparatus and a valve arrangement according to the appended claims.

The present disclosure provides a valve arrangement operable to selectively alternately open and close at least a first and a second fluid delivery line.

The valve arrangement may comprise a valve member movable between a first position in which a first fluid delivery line is open and a second fluid delivery line is shut-off, and a second position in which the first fluid delivery line is shut-off and the second fluid delivery line is open.

In a first aspect of the present disclosure, the valve arrangement may be used in a beverage preparation apparatus. The beverage preparation apparatus may comprise the first fluid delivery line and the second fluid delivery line. The apparatus may further comprise one or more fluid outlet nozzles.

The valve member may be mechanically coupled to the fluid outlet nozzle such that moving the fluid outlet nozzle between the stowed and operational position shifts the valve member between the first and second positions and returning the fluid outlet nozzle to the stowed position shifts the valve member from the second position to the first position.

The fluid outlet nozzle may comprise a steam outlet (which may be referred to as a steam wand), a hot water outlet nozzle or a beverage outlet nozzle. The beverage outlet nozzle may comprise a coffee or hot chocolate or hot water outlet nozzle, for example. The beverage outlet nozzle may be multi-purpose and dispense a plurality of different fluids. The deployment of the fluid outlet nozzle between the stowed and operational positions may be linear, rotational or pivotable.

The valve arrangement may be a pinch valve. The valve member of the pinch valve may be configured to compress the first and second fluid delivery lines to shut-off the lines in the respective first and second positions. The valve member may comprise one or more compressing portions which are urged against an external surface of the first and second fluid delivery lines to shut them off. The valve member may comprise a valve body which is rotatable about a valve member rotational axis. The compression portions of the valve member may be provided on opposite sides of the rotational axis. The compression portions may be diametrically opposite. The valve body may comprise an actuation point from which a coupling, such as a lever, is attached to provide a driving rotating force. The valve member may comprise a biasing member attachment point (which may be referred to as a biasing point) on an opposing side of the actuation point. The biasing point may be diametrically opposite to the actuation point. Rotating the valve member at either the actuation point or biasing point may cause the compression portions to contact a respective fluid delivery line.

Each of the first and second delivery lines may comprise a compressible portion which comprises a material which is readily compressible by the valve member. The materials of the compressible portion may comprise an elastomeric material and are preferably made from silicone. The delivery lines may have a diameter between 0.5 mm and 5 mm, and a wall thickness of between 0.3 mm and 1.5 mm.

The first and second fluid delivery lines may be provided on opposing sides of the valve member. The valve member may be configured to shift laterally between first and second positions to compress the respective first and second delivery lines. Thus, the first and second fluid delivery lines (the compressible portions thereof at least) and the valve member may be provided in a common plane in which the valve member transitions.

The valve arrangement may comprise a valve housing. The valve housing may comprise one or more channels in which the first and second fluid delivery conduits are located. The first and second fluid delivery lines may be located to either side of a central region of the valve housing. The valve member may be located within the central region. The valve housing may comprise a first part and a second part which are assembled together following insertion of the first and second fluid delivery lines. The first and second parts may be attached to one another using suitable fixing means.

The valve housing may comprise a first side and a second side. An edge of the housing (which may be referred to as a top edge) may extend between first and second sides. The first and second fluid delivery lines may be configured to exit opposing sides of the valve housing. The first and second fluid delivery lines may exit the valve housing through the first and second sides respectively. A lever which actuates the valve member may enter the housing via the top edge between the first and second sides. The first and second fluid delivery lines may extend perpendicularly away from the first and second sides. It will be appreciated that use of the terms first and second sides and top edge are used arbitrarily and in a non-limiting way.

The valve housing may be cuboidal having a length, width and thickness. In some embodiments, The length may be between 40 mm and 70 mm, the width may be between 30 mm and 45 mm, and the thickness may be between 12 mm and 20 mm.

The valve may comprise a biasing member to bias the valve member against the first and second fluid delivery lines when in the respective first or second positions. The biasing member may be configured to provide a bi-stable switching operation in which the valve member is resiliently urged into each of the first and second positions. The biasing member may provide a compressive force which resists the switching of the valve member from the first position and the second position and vice versa. The compressive force may be provided for only part of the stroke of the valve member. The biasing member may be configured to flip from a first position compressive force to a second position compressive force as the valve member transitions between the first and second positions, and vice versa.

The biasing member may be configured to provide a compressive force for shutting off the first and second fluid delivery lines when in the second and first positions respectively. Thus, the biasing member may be configured to forcibly drive the compression portion of the valve member into the first and second fluid delivery lines.

The biasing member may comprise any suitable biasing member. In some embodiments, the biasing member may comprise a helical spring. There may be a plurality of biasing members in some embodiments.

Various options and features of the biasing member and configuration of the valve arrangement are provided in relation to the second aspect below.

The lateral shift of the valve member may comprise a rotation of the valve member about a rotation axis. The axis of rotation may be defined by a pivot. The pivot may comprise a shaft on which the valve member is mounted. The rotation of axis may be perpendicularly arranged with respect to the first and second fluid delivery lines.

The valve member may comprise a biasing point against which the biasing member urges the valve member into either the first or second positions. The biasing point may comprise an attachment point for a biasing member, or the point against which the force vector of the biasing member acts to bias the valve member against the fluid delivery lines.

The valve member may comprise a first compressing portion for compressing the first fluid delivery line and a second compressing portion for compressing the second fluid delivery line. The first and second compressing portions may be located on opposing sides of a line which extends between the axis of rotation and biasing point. The first and second compression points may be provided on a peripheral edge of the valve member. The biasing point may be provided on a portion of the peripheral edge which is located between the first and second compression portions. The radial distance between the axis of rotation and the compression portions may be the same. The radial distance between the axis of rotation and the biasing point may be the same, less or greater than the radial separation of the compression points and the axis of rotation.

The biasing member may extend between an anchor located on a valve housing and the biasing point. The rotation axis, biasing point and anchor may lie along an axis (a straight line) when the valve member is provided in a central position between the first and second fluid delivery lines. The axis may provide a centre line for the valve arrangement. The separation between the biasing point and the anchor may be at a minimum when the valve member is located centrally between the first and second fluid delivery lines.

The housing may comprise an enclosure in which the valve member and first and second fluid delivery lines are located. The first and second fluid delivery lines may be located laterally with respect to a central region in which the valve member is located. The first and second fluid delivery lines may be located within channels provided by the valve housing. The biasing member anchor may be located in the central region.

The valve housing may comprise a first end and a second end with sides extending therebetween. The first and second fluid delivery lines may be located within the sides. The valve member may be located towards the first end. The anchor may be located towards the second end.

A coupling member may be attached to the valve member. The coupling member may comprise a lever. The coupling member may project outwardly from the first end of the valve housing. The coupling member may be configured to move laterally between the first and second fluid delivery lines to affect the lateral movement of the valve member between the first and second shut-off positions.

The first and second compression portions of the valve member may be configured to compress the first and second fluid lines in a direction which is perpendicular to the longitudinal axis of the first or second fluid delivery lines.

Although the first aspect relates predominantly to the use of a fluid outlet nozzle for the actuation of the valve member, this is not a limitation of the present disclosure and any user actuated element required for the preparation a beverage may be used to actuate the valve member. The fluid outlet nozzle comprises a steam outlet nozzle (which may be referred to as a steam wand), a hot water outlet or a beverage dispensing nozzle.

The valve arrangement may further comprise a lever which couples the valve member to the fluid outlet nozzle. The lever may be operable to transition the valve member between first and second positions as the fluid outlet nozzle is moved between the stowed and operating positions. The lever may be an integral part of the valve member or a discrete part which is received by or attached to the valve member during assembly of the beverage preparation apparatus. The lever may be an elongate member which extends between the valve housing and nozzle outlet mechanism determines and/or controls the movement of the fluid outlet nozzle.

The lever may engage with a track on a fluid outlet nozzle mechanism. The track may provide a running surface against which the lever may be slidably guided during movement of the fluid outlet nozzle mechanism. The sliding movement of the lever on the runner may cause the movement of the lever relative to the valve housing and cause actuation of the valve member.

The fluid outlet nozzle mechanism may comprise at least one member. The member may be an arm. The member may be attached to the beverage preparation apparatus (or a stationary structure thereof) by a rotatable connection. Hence, the member may be rotated about a rotational axis when moving the fluid outlet nozzle from the stowed position to the deployed position.

The track may comprise at least one runner which is eccentrically arranged with respect to the rotational axis of the member such that rotating the member displaces the valve member from the first position to the second position (or vice versa). The eccentrically arranged runner may comprise a surface which is separated from the rotational axis by a first distance when in a first rotational position and by a second distance which is less than the first distance when in a second position. The measurement of the distance may be radial distance along the line along which the lever moves, that is, a common angular location in relation to the rotational axis of the member.

The at least one runner may comprise a first runner configured to move the valve member from the first position to the second switch position, and a second runner configured to move the valve member from the second switch position to the first switch position. The second runner may be eccentrically arranged with respect to the rotational axis of the member such that rotating the member displaces the valve member from the second position to the first position. The eccentrically arranged runner may comprise a surface which is separated from the rotational axis by a third distance when in the second rotational position and by a fourth distance which is less than the first distance when in the first rotational position. The measurement of the distance may be a radial distance along the line along which the lever moves, that is, a common angular location in relation to the rotational axis of the member.

The lever may be configured to move between the first and second runners under the influence of the biasing member.

The beverage preparation apparatus may further comprise a fluid source connected to the first fluid delivery line and, optionally, the second fluid delivery line. The first fluid delivery line may be connected to the fluid outlet nozzle and, optionally, wherein the second fluid delivery line is connected to the fluid outlet nozzle. The fluid may be a liquid or a gas, including steam, for example.

In a second aspect, the present disclosure may provide a bi-stable valve arrangement for shutting-off a first fluid delivery line and a second fluid delivery line. The valve arrangement may comprise a valve member movable between a first position in which a first fluid delivery line is open and a second fluid delivery line is shut-off, and a second position in which the first fluid delivery line is shut-off and the second fluid delivery line is open.

The valve arrangement may further comprise a biasing member configured to urge the valve member against the second delivery line when in the first position and the first delivery line when in the second position. The urging of the biasing member may be sufficient to shut-off the first and second delivery lines.

The valve member may move through a biasing threshold when moving from the first position to the second position and form the second position to the first position. The biasing member may be configured to resist movement of valve member when moving away from either of the first or second delivery lines prior to moving through the biasing threshold. The biasing member may be configured to urge the valve member away from the biasing threshold towards the other of the first or second fluid delivery lines once through the biasing threshold.

The extent of the movement of the valve member between the first and second positions (or vice versa) may be referred to as the throw of the valve member. The biasing threshold may be provided at a mid-point of the throw. Thus, the biasing member may provide a resistive force acting against the direction of actuation in the first half of the throw, and a driving force acting in the direction of the actuation in the second half of the throw.

The valve member may be configured to move laterally between the first and second positions. Thus, the first and second fluid delivery lines may be on opposing sides of the valve member. The valve member may be rotatable about a rotational axis.

The biasing member may be configured to urge the valve member around the rotational axis when not at the biasing threshold. The spring force vector of the biasing member may be tangential to the rotational axis of the valve member on either side of the biasing threshold. When in the first or second positions, the spring force vector may be directed towards the first or second fluid delivery lines.

The valve member may comprise a biasing point against which the biasing member urges the valve member into either the first or second positions. The biasing point may be radially offset from the rotational axis of the valve member.

The biasing point may comprise an attachment point for the biasing member. The biasing point may be provided by a pin, stub or other protuberant feature about which a compression spring may be mounted. Alternatively, the biasing member may be located in a socket or otherwise attached to the valve member.

The biasing member may extend between an anchor point located on a valve housing and the biasing point. The anchor point may be radially separated from the valve member and rotational axis. For example, the valve member may be located towards a central region of the valve housing with the anchor point being provided at an end or towards a side of the valve housing so as to be suitably separated from the rotational axis and biasing point of the valve member.

The rotational axis, biasing point and anchor point may lie along an axis when the valve member is provided in a central position between the first and second positions. The valve arrangement may comprise a centre line along which the anchor point and rotational axis are provided. Compression points of the valve member which are urged against the respective first and second delivery lines may be located symmetrically on either side of the centreline when the valve member is positioned in a neutral position between the first and second positions. The biasing member may be provided at a mid-point between the compression points of the valve member. The biasing point may be located on the centreline when the valve member is provided in the neutral position.

The biasing threshold may correspond to the centreline and may represent a position of the valve member in which the force vector of the biasing member lies along the centreline between the anchor point and through the biasing point and rotational axis.

The biasing member may be configured to move away from the centreline with as the valve member transitions between the first and second positions. The valve housing may comprise one or more chamber walls to restrain lateral movement of the biasing member when in the first and second positions.

The skilled person will appreciate that except where mutually exclusive, a feature described in relation to any one of the aspects, embodiments or examples described herein may be applied mutatis mutandis to any other aspect, embodiment or example. Furthermore, except where mutually exclusive, any feature described herein may be applied to any aspect and/or combined with any other feature described herein.

Hence, for example, any feature of the first aspect may be incorporated into the valve arrangement of the second aspect, and any feature of the valve arrangement of the second aspect may be incorporated into the beverage preparation apparatus of the first aspect.

### BRIEF DESCRIPTION OF THE DRAWINGS

In order that the invention may be more clearly understood one or more embodiments thereof will now be described, by way of example only, with reference to the accompanying drawings, of which:

FIGS. 1a and 1b show the internal structure of a valve according to the present disclosure in first and second positions respectively;

FIG. 2 shows an external view of the valve of FIGS. 1a and 1b;

FIG. 3 shows a schematic layout of a beverage preparation apparatus comprising a valve of the present disclosure;

FIG. 4 shows a perspective view of a steam wand which may be used to actuate a valve of the present disclosure; and,

FIGS. 5a and 5b show the steam wand in a stowed and deployed position respectively.

### DETAILED DESCRIPTION OF THE INVENTION

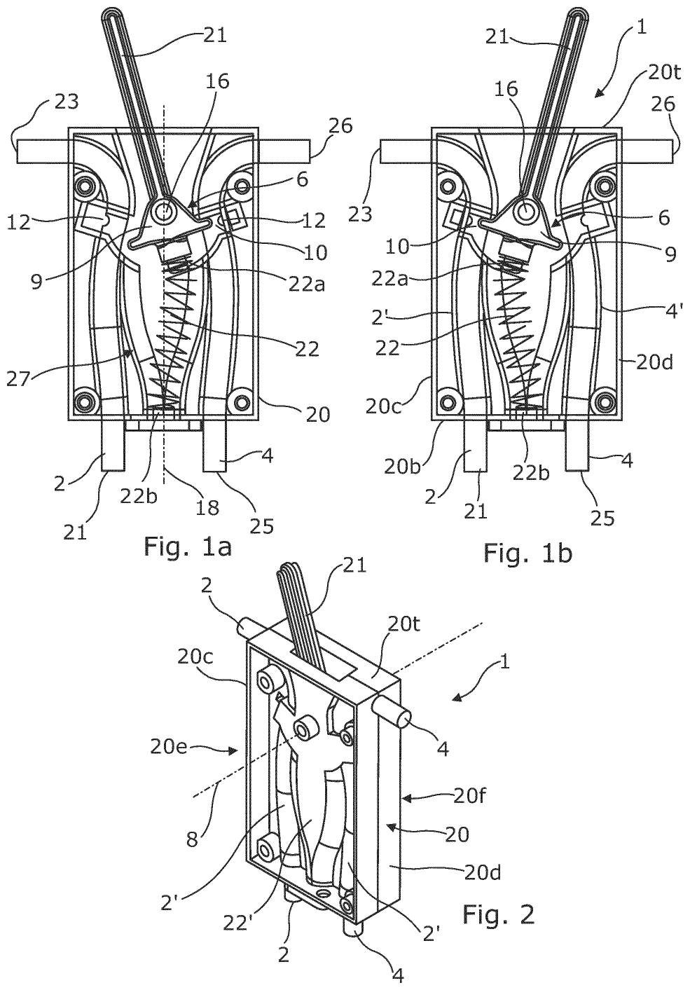

With reference to FIGS. 1a, 1b and 2 there is shown a valve arrangement 1 according to the present disclosure. The valve 1 is configured to alternately shut-off first 2 and second 4 fluid delivery lines so as to prevent a flow of fluid therethrough.

The valve arrangement 1 may comprise a valve member 6 having a first position (as shown in FIG. 1a) in which the first fluid delivery line 2 is open and a second fluid delivery line 4 is shut-off, and a second position (FIG. 1b) in which the first fluid delivery line 2 is shut off and the second fluid delivery line 4 is open. Hence, in use, the valve arrangement 1 is operable to allow a fluid flow path through either one of the first 2 and second 4 delivery lines, but not both. As such, the valve arrangement 1 may be configured to operate as a two-way valve, switch-over valve, change-over valve, or selector valve (amongst other configurations).

The valve member 6 may be rotatable about a rotational axis 8 so as to move laterally between the first and second positions. The valve member 6 may comprise a main body 9 and first and second compressing portions 10 for urging into the respective first and second fluid delivery lines to shut-off. The compressing portions 10 may be in the form of protuberant features, e.g. stubs, which extend laterally out of the main body 9 of the valve member 6 and contact the respective delivery line 2, 4 wall. The relative positioning of the first and second delivery lines and the movement of the valve member may be arranged to provide a perpendicular pinching of the respective delivery line when in the respective shut-off position, as shown. A corresponding valve seat compression portion 12 may be located on an opposing side of the delivery line 2, 4 to provide pincer formation between which the lines 2, 4 can be compressed and shut-off more effectively.

The rotational axis 8 may be defined by a pivot shaft 16 upon which the valve member 6 is mounted. The delivery lines 2, 4 may be provided to laterally on opposing sides of the rotational axis 8 and equidistantly therefrom. The rotational axis 8 may be provided on or define a centreline 18 of the valve 1.

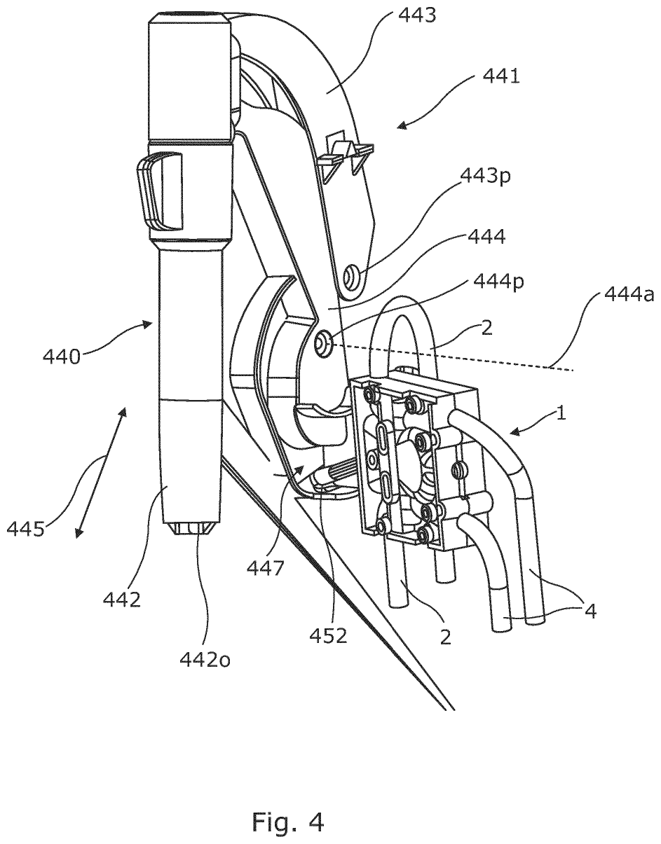

In order to acuate the valve arrangement 1, specifically the valve member 6, an outlet nozzle 440 (as shown in FIG. 4) of the beverage preparation apparatus may be mechanically coupled to the valve member 6 such that moving the fluid outlet nozzle 440 causes a switching of the valve member 6 from the first position to the second position or vice versa.

Linking the actuation of the valve member 6 to the movement of the outlet nozzle 440 is advantageous as it allows the fluid supply which is utilised by the fluid outlet nozzle 440 to be switched as the fluid outlet nozzle 440 is moved into place for use. Additionally or alternatively, the actuation of the valve member 6 may shut-off one or more lines which are not required during the use nozzle 440 thereby providing a convenient way of switching between lines and functions of the beverage preparation apparatus with a single user instigated action.

The valve arrangement 1 may be a mechanical valve in that it does not require electrical, pneumatic or hydraulic power to operate it. Further, the mechanical valve may be directly operable via an action of the user. As such, the arrangement may provide a simple, inexpensive way to implement change over valve for use in a beverage preparation apparatus.

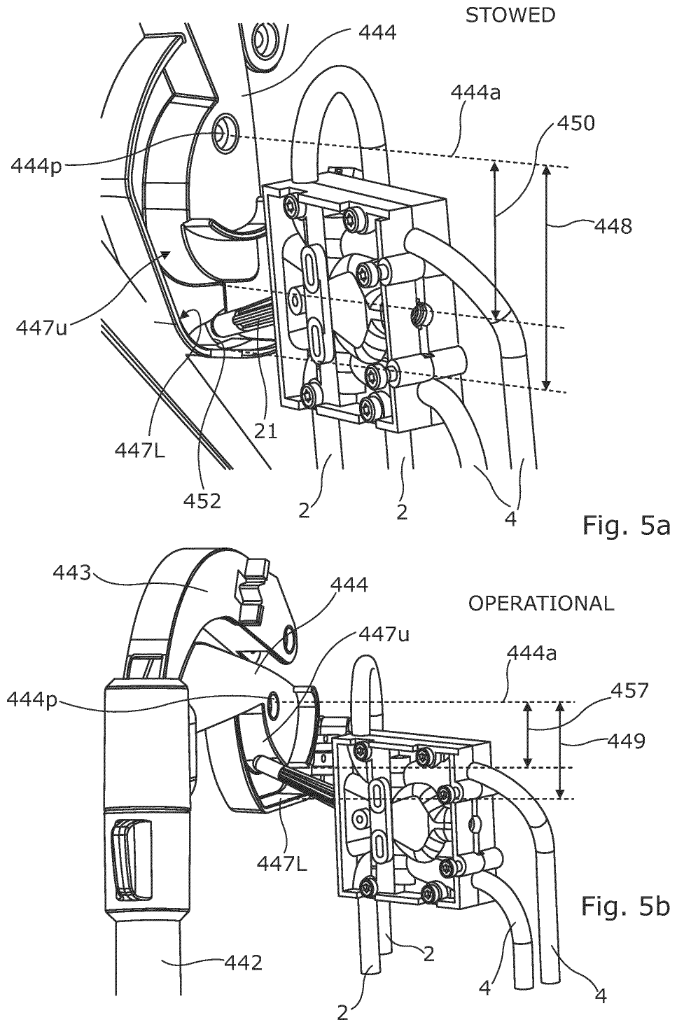

The movement of the valve member 6 may be achieved by an elongate member (which may be referred to as a valve lever 21) which protrudes from the valve housing 20. The lever 21 may operable directly by a user, or via a user actuated fluid delivery nozzle of the beverage preparation apparatus. Thus, as shown in FIGS. 4, 5a and 5b and described in further detail below, the valve arrangement 1 may be operable with the movement of a fluid outlet nozzle 440 in the form of, for example, a steam wand, a hot water nozzle or another fluid outlet nozzle for preparing a beverage.

The fluid outlet nozzle 440 may be movable from a stowed position (e.g. a non-use position) (FIG. 5a), into a deployed or operational position (FIG. 5b) in which the nozzle 440 may be used for a primary purpose, namely the ejection of fluid for the purposes of preparing the beverage. For example, in the case of a steam wand, the nozzle 440 may be stowed within or proximal to a housing of the beverage preparation apparatus and moved into a working zone away from the apparatus housing when required.

The valve member 6 may be configured to be switchable between the first and second positions in a bi-stable manner such that, once switched and located in the first or second positions against the respective delivery line 2, 4, it requires an additional force to disengage the valve member 6 and move it across to the other delivery line 2, 4. Further, the valve member 6 may be biased such that moving it beyond a biasing threshold point in between the first and second positions, results in the valve member 6 being urged into place by the biasing member. In doing so, it ensures that the valve member 6 is firmly located in place independently of the user action once the biasing threshold has been passed. Further, the biasing action may be configured to provide a force which is suitable to provide an audible ‘click’ to indicate that the valve arrangement 1 has successfully actuated.

In order to achieve the bi-stable operation, the embodiment of FIG. 1 comprises a biasing member 22 in the form of a helical compression spring which extends between a biasing point 22a on the valve member 6 to an anchor point 22b on the valve housing 20. The rotational axis 8 and anchor point 22b define a centreline 18 of the valve arrangement 1 which passes equidistantly between the first 2 and second 4 delivery lines at the pinch portion of each. Hence, if the valve member 6 were positioned in a mid-throw position between the first 2 and second 4 delivery lines such that neither delivery line is closed, the rotational axis 8, biasing point 22a and anchor point 22b would lie along the centreline 18.

The rotational axis 8 and anchor point 22b are fixed relative to one another, the housing 20, and the first 2 and second 4 delivery lines. The biasing point 22a is moveable away from the centre line 18 towards the first 2 or second 4 delivery line when the valve member 6 is rotated. When the valve member 6 is mid-throw between the first and second positions, the biasing point 22a may lie on the centreline. At this point, the force vector of the biasing member is aligned along the centreline and towards the rotational axis 8. This position provides the biasing threshold such that moving either side of the centreline 18 would result in the biasing member 22 driving the valve member 6 toward the first or second position.

More specifically, the arrangement of the rotational axis 8, biasing point 22a, anchor point 22b, the biasing member 22 and the valve member 6 is such that, as the valve member 6 is rotated away from the centre line 18, the spring force vector of the biasing member 22 moves laterally away from the rotational axis 8 so as to drive the rotation of the valve member 6 towards and into the delivery line 2, 4 which is due to be shut off. That is, the biasing member 22 urges the valve member 6 into contact with the delivery line 2, 4 and provides the compressive force for shutting off the delivery line 2, 4.

When the valve 1 is switched, the valve member 6 is rotated by a user which results in a compression of the biasing member 22 until such a time that the biasing point 22a passes the centreline 18 and biasing threshold at which point the biasing member 22 urges the valve member 6 in the direction it is being moved in and against the second delivery line 2. As such, the centre line 18 may provide a biasing threshold which marks a change over between the biasing member 22 acting against the movement of the valve member 6, to one in which it is urging the valve member 6 in the direction of the actuation. As will be appreciated, this biasing bi-stable action provides definitive feedback for the user as to the switching action and ensures the respective delivery line 2, 4 remains fully closed until such time that a positive forcible switching action is provided by a user.

It will be appreciated that the position and relative spacing of the rotational axis 8, biasing point 22a and anchor point 22b may be adjusted to alter the force provided by the biasing member 22. It will be appreciated that increasing the spring force of the biasing member 22 may provide an improved tactile sensation or feedback for the user, and may be used to provide improved isolation properties for the valve 1.

The biasing member 22 may be any suitable biasing member which can drive the rotation of the valve member 6 into the respective delivery line 2, 4. The use of a helical spring as shown in FIG. 1 is particularly advantageous due to the low cost and range of sizes and spring forces which are available, but other forms of biasing member 22 may be possible.

The valve member body 8 and housing 20 may comprise any suitable form which allows the biasing member 22 to be attached at the biasing point 22a and the anchor point 22b. In the embodiment shown, each of the valve member 6 and the housing comprise a short stub which is configured to be located within the internal bore of the biasing member 22. However, other arrangements will be possible. For example, either or both of the housing 20 or valve member 6 may comprise a socket into which the biasing member 22 may be inserted.

### Housing

The valve arrangement 1 may comprise a housing 20 which provides structural support for the first 2 and second 4 delivery lines and the valve member 6.

The valve housing 20 may be any suitable size or shape and be of any type of construction required to fulfil the valve functions described herein. The housing 20 shown in FIG. 2 is generally planar having a top 20t, a bottom 20b, and minor sides 20c,d and major sides 20e,f. The external walls of the housing 20 are single skinned and shaped to correspond to the various channels and chambers defined therein for housing the delivery lines 2, 4, the biasing member 22 and the valve member 6. The housing 20 may be constructed from two or more parts which are joined together by suitable fixing means such as screws or bolts.

Appropriate sized apertures may be provided in the minor sides 20c,d or the external walls for the lever 21 and first and second delivery lines 2,4. The apertures for the delivery lines 2, 4 may correspond closely to the external diameters of the lines 2, 4, whilst the aperture of the lever 21 may be elongate so as to allow the actuating movement of the lever 21 during switching. The anchor point 22b may be provided on an internal surface of the bottom wall 20b.

The first 2 and second 4 delivery lines may be received within appropriately sized channels defined by internal walls of the housing 20. The channels 2′, 4′ may be sized to snugly receive the delivery lines 2, 4 such that they are clamped firmly in place during use and do not deform, particularly at the pinch point of the valve member 6, when being shut off. In the embodiment shown, the delivery lines 2, 4 follow respective meandering paths which extends from first ends 21, 25 at a lower end of the housing 20 on either side of the anchor point 22b to second ends 23, 26 on the flanks of the housing 20 above the valve member 6.

The lateral exit point of the delivery lines 2, 4 is convenient in the embodiment shown in FIGS. 1a and 1b as it ensures the lines do not obstruct the movement of the lever 21 during switching. However, it will be appreciated that the entry and exit points of the first 2 and second 4 delivery lines 2, 4 may be located in different places to those shown and the arrangement may not be symmetrical in some embodiments. The first and second ends of the first 2 and second 4 delivery lines is selected arbitrarily and does not necessarily relate to a flow direction of the fluid lines in use.

The delivery lines 2, 4, are arranged in the housing 20 such that the pinch portion which is compressed by the valve member 6 is presented in a generally perpendicular orientation to the compressive force provided by valve member 6 and the biasing member 22, thereby helping to ensure the delivery line flow path is correctly cut-off. As such, the first and second delivery lines 2, 4 may be angled towards each other at the pinch portions prior to curving outwardly to exit the sides 20c,d of the housing 20.

The biasing member 22 may be located in a central portion of the housing 20 between the first 2 and second 4 lines. In the embodiment shown, a biasing member chamber 22′ is provided by the internal walls of the housing 20. The biasing member chamber 22′ may be shaped with lateral edges which broadly correspond to the shape of the biasing member 22 when the valve member 6 is in the first and second switch positions. In doing so, the lateral edges of the biasing member 22 may be supported to prevent a unnecessary lateral deflection and help guide the force vector of the biasing member 22 towards the pinch point.

In the embodiment shown, the delivery lines 2, 4 curve around the biasing member chamber 22′ and exit the bottom 20b of the housing inset slightly from the corner region which accommodates a fixing point.

The lever 21 which is operably connected to the valve member 6 extends out from an upper surface 20t of the housing 20 such that it can be engaged either by hand or by the aforementioned outlet nozzle. The lever 21 is received within a slot to allow the range of motion required to rotate the valve member and may be flanked internally by opposing walls as shown.

It should be noted that reference to the top and bottom surfaces on the housing 20 are arbitrary and these may be referred to first or second sides or surfaces etc, where necessary.

### The Delivery Lines

The delivery lines 2, 4 may be any suitable delivery lines known in the art. Typically, delivery lines for a pinch valve will comprise a portion of compressible wall which can be pinched by the valve member 6 to shut off the flow passage within the line. Typical materials for the delivery line may include an elastomeric material and are preferably silicone. The delivery lines may have a diameter of between 0.5 mm and 5 mm, and a wall thickness of between 0.3 mm and 1.5 mm.

The valve arrangement 1 of the present disclosure may be used in any suitable application in which a pair of fluid delivery lines 2, 4 require simultaneous alternate switching. The delivery lines 2, 4 may be entirely independent of one another or may originate from a common source or exit to a common outlet nozzle. Hence, for example, the beverage preparation apparatus may comprise a first fluid source which is deliverable to first and second outlets, or first and second fluid sources which are deliverable to a single outlet, or first and second fluid sources which are deliverable to independent first and second outlets.

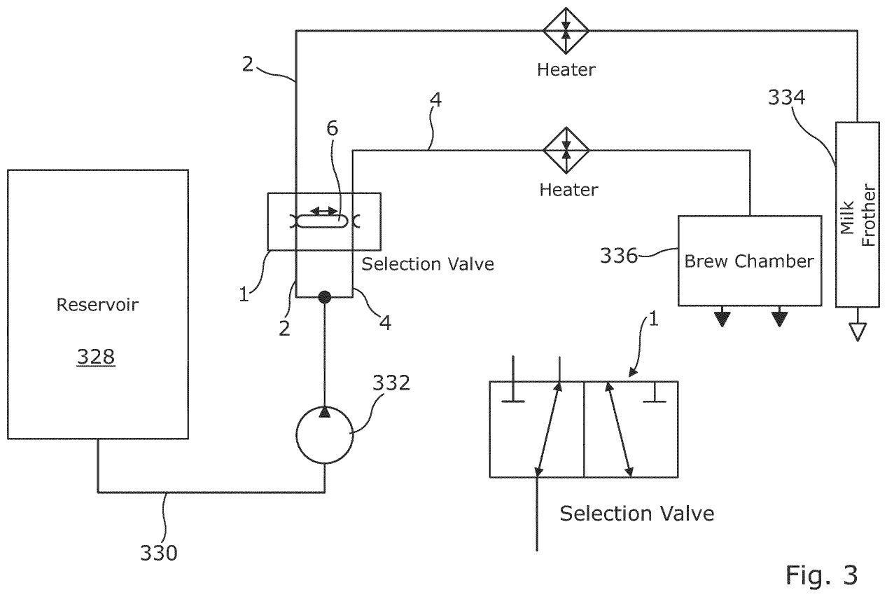

In the example shown in FIG. 3, there is shown a reservoir chamber 328 which is upstream of the valve arrangement 1. A primary delivery line 330 extends between the chamber 328 and the valve arrangement 1 (via a pump 332). A primary line 330 bifurcates to provide the first 2 and second 4 delivery lines upstream of the valve 1. Downstream of the valve arrangement 1, the first delivery line 2 may terminate in the steam wand 334 and the second delivery line 4 may extend to a brew chamber 336. As both the steam wand 334 and the brew chamber 336 are used exclusive of each other during the use of the apparatus, it is possible for the chamber 328 to be shared between the two. Further, configuring the valve arrangement 1 so that it is operable with the movement of the steam wand 334 or an outlet nozzle which is in fluid communication with the brewing chamber 336, means the switching between lines 2, 4 may be simplified.

As noted above, the valve arrangement 1 may be a fully mechanical valve and may be actuated by a user action, or by a motorised or electronically activated system, however a manual (user) action is preferred. The user action may be one in which an outlet nozzle of the beverage preparation apparatus is moved into an operational position from, for example, a stowed position. The outlet nozzle may be a steam wand, beverage dispensing nozzle or a hot water nozzle for example. However, the valve arrangement 1 may find applications for other types nozzles in different embodiments and the valve arrangement 1 may also be used with user operated devices other than nozzles. For example, the valve arrangement 1 may be used with a milk wand for drawing milk into the apparatus. Other examples may exist.

FIGS. 4, 5a and 5b show an example of an outlet nozzle 440 in the form of a steam wand 442 which is movable between a stowed position and an operational position via an outlet nozzle actuation mechanism 441 (which may be referred to as a steam wand mechanism). FIGS. 4 and 5a show the steam wand 442 in the stowed position, with FIG. 5b showing the operational position.

The specific arrangement of the steam wand mechanism 441 which guides travel between the stowed and operational positions may vary across embodiments. However, the outlet nozzle will generally be coupled to the valve arrangement 1 to cause it to switch upon a predetermined amount of movement of the outlet nozzle between the first and second positions.

As noted above, the valve arrangement 1 may comprise a valve member 6 which may be switched using a lever 21. Hence, the lever 21 may be coupled to the steam wand mechanism 441 such that moving the steam wand 442 causes the movement of the lever 21 and switching of the valve arrangement 1. The connection between the lever 21 and the steam wand mechanism 441 may be direct, as shown in FIG. 4, or may be via one or more gears or interconnecting levers or shafts, for example. Further, the lever 21 may form part of the mechanism 441 and be distinct from the stand-alone valve arrangement 1.

With specific reference to FIGS. 4, 5a and 5b, there is shown the steam wand mechanism 441 comprising the steam wand 442 which is movable in a generally vertical and forwards direction away from a housing (not shown) of the apparatus between the stowed and operational positions, as indicated by arrow 445. The steam wand 441 comprises an internal passageway for delivery of the steam from one of the delivery lines 2,4 to one or more outlets located towards the free end 442o of the wand 440. The steam wand mechanism 441 shown in FIG. 4 comprises first and second swing arms 443, 444 which guide the movement of the steam wand 442. The first and second arms 443, 444 are each connected to suitable anchor points of the apparatus via respective pivot connections 443p, 444p at a first end thereof. The second end of the arms 443, 444 are connected to the steam wand 442 by corresponding pivot connections (not shown).

The valve arrangement 1 comprising the housing 20 and the first and second delivery lines 2, 4 is shown to the right of the steam wand mechanism 441 and rotated through 90 degrees with respect to the orientation shown in the previous figures. As previously noted, the delivery lines 2, 4 may be connected to the same or different inputs and outputs, however, in the embodiment shown in FIG. 4, at least one of the delivery lines 2,4 is connected to the steam wand passageway. The connection of the delivery line 2,4 is not shown for the sake of clarity but will typically comprise one of the fluid delivery lines 2,4 extending through a central passageway of the upper arm before descending down towards the outlet end 442o of the wand 442.

The lever 21 can be seen extending out of the end of the housing 20. The other elements of the valve arrangement 1 can be assumed to be the same as those described above in FIGS. 1a and 1b.

The lever 21 engages with an actuation track 447 provided by the steam wand mechanism 441 such that movement of the steam wand 442 causes actuation of the lever 21 and switching of the valve member 6. The track 447 is provided by the second, lower arm 444 in the embodiment shown but this is not a limitation and the coupling between mechanism 441 and the valve member 6 may be provided by any suitable part including, for example, the upper arm or wand itself or some other element of the outlet nozzle as may be convenient.

The track 447 may comprise an upper runner 447U and a lower runner 447L. The upper 447U and lower runners 447L may be configured to move the lever 21 upon movement of the steam wand 442 and rotation of the lower arm 444. This may be achieved providing the upper 447U and lower 447L runners with surfaces which are eccentrically arranged with respect the rotation of the arm 444 such that rotating the arm 444 urges the lever 21 downwards or upwards as required.

The exact shape of the runners 447U, 447L may vary between embodiments and they may be curved and/or straight. The radius of curvature may not be constant around the runner surface such that the curvature changes along the length and there may be one or more straight portions.

The deflection of the lever 21 provided by the runners 447U and 447L during movement of the arm 444 is sufficient to move the lever 21 by an amount which results in the switching of the valve member from one delivery line 2,4 to the other. For the embodiment described in connection with FIGS. 1a, 1b, the movement of the lever 21 needs to be sufficient to overcome the biasing threshold such that the biasing member 22 can move from a compressive state in the first part of the throw to an expansive state in the second part of the throw in which it drives the valve member 6 into the delivery line 2,4 which is to be shut-off.

As best seen in FIG. 5a, when the steam wand 442 is in the stowed position the lever 21 is located on or in close proximity to the lower runner 44L. When the steam wand 442 is in the operational position, as shown in FIG. 5b, the lever 21 is located on or in close proximity to the upper runner 447U, where it resides until the steam wand 442 is moved back into the stowed position.

As can be seen in FIG. 5a, the lower runner 447L is configured such that the radial separation between the runner 447L and the rotational axis 444a/pivot 444b of the arm 444 at the location of the lever 21 reduces as the arm 444 moves from the stowed to the operational positions. Hence, with reference to the location of the lever 21, the separation between the lower runner 447L and pivot 444p is a first distance 448 in the stowed position, and a second distance 449 in the operational position, wherein the first distance is greater than the second distance. It will be appreciated that by “location of the lever”, it is meant the angular location, rather than the radial location. Hence, as the arm 444 is moved, the runner 447L slides under the lever 21 and displaces it vertically upwards towards the pivot 444p.

Conversely, the upper runner 447U is configured such that the radial separation between the runner 447U and pivot 444p increases as the arm 444 is moved from the operational position to the stowed position. Hence, dimension 450 in FIG. 5a is greater than the corresponding dimension 451 in FIG. 5b.

The upper and lower runners 447U, 447L may be provided with terminal ends which have a radius of curvature which is concentric to the rotational axis 444a of the arm 444. Hence, the arm 444 may be configured to allow a small amount of movement of the steam wand 442 without displacing the lever 21 and unintentionally opening or closing the valve.

The upper and lower runners 447U, 447L may be modified with one or more ramp formations 452 upon which the lever 21 rests. Such a ramp formation is shown in FIG. 5a where a corner region of the lower runner 447L is filleted. The radius of the fillet may increase along its length such that the fillet gets larger towards the terminal end of the runner 447L which is associated with the end the range of travel of the swing arm 444.

As noted above, the biasing member 22 may be configured urge the valve member 6 across the second half of the throw once the biasing threshold has been overcome. When this occurs, the lever 21 may move away from the actuating runner 447U, 447L under the influence of the biasing member 22. To allow for this the runners 447U, 447L may be separated by a gap which is significantly larger than the width of the lever 21 to allow space for the lever 21 to move under the influence of the biasing member 22.

The actuation of the valve arrangement 1 under the influence of the biasing member 22 may be configured such that the contact with the opposing runner results in an audible click to indicate to a user that the valve has operated.

The present disclosure provides a valve arrangement which may be used to switch over fluid delivery lines. In some embodiments, the valve arrangement may advantageously be fully mechanical and operated by a user action. The user action may be one which is otherwise required for the preparation of a beverage, such as moving a fluid outlet nozzle between a stowed or operational position. The valve may be bistable in that it is urged into the respective delivery line by a biasing member.

The one or more embodiments are described above by way of example only. Many variations are possible without departing from the scope of protection afforded by the appended claims.

1. A beverage preparation apparatus, comprising:
a first fluid delivery line;
a second fluid delivery line;
a fluid outlet nozzle which is movable between a stowed position and an operational position and configured to receive fluid from at least the second delivery line when in the operational position; and,
a valve arrangement having a valve member movable between a first position in which the first fluid delivery line is open and the second fluid delivery line is shut-off, and a second position in which the first fluid delivery line is shut-off and the second fluid delivery line is open,
wherein the valve member is mechanically coupled to the fluid outlet nozzle such that moving the fluid outlet nozzle between the stowed and operational position shifts the valve member between the first and second positions and returning the fluid outlet nozzle to the stowed position shifts the valve member from the second position to the first position.

2. The apparatus of claim 1, wherein the first and second fluid delivery lines comprise compressible portions which are compressed by the valve member when shut-off.

3. The apparatus of claim 2, wherein the first and second fluid delivery lines are provided on opposing sides of the valve member, wherein the valve member is configured to shift laterally between first and second positions to compress the respective first and second delivery lines.

4. The apparatus of claim 2, wherein the valve further comprises a biasing member to urge the valve member against the first and second fluid delivery lines when in the respective first or second positions.

5. The apparatus of claim 4, wherein the biasing member provides a compressive force for shutting off the first and second fluid delivery lines when in the second and first positions respectively.

6. The apparatus of claim 4, wherein the biasing member comprises a helical spring.

7. The apparatus of claim 4, wherein the lateral shift comprises a rotation of the valve member about a rotation axis.

8. The apparatus of claim 7, wherein the valve member comprises a biasing point against which the biasing member urges the valve member into either the first or second positions and,
wherein the valve member comprises a first compressing portion for compressing the first fluid delivery line and a second compressing portion for compressing the second fluid delivery line,
wherein the first and second compressing portions are located on opposing sides of a line which extends between the rotation axis and the biasing point.

9. The apparatus of claim 8, wherein the biasing member extends between an anchor point located on a valve housing and the biasing point.

10. The apparatus of claims 7, wherein the rotation axis, biasing point and anchor point lie along an axis when the valve member is provided in a central position between the first and second positions and between the first and second fluid delivery lines.

11. The apparatus of claim 1, wherein the fluid outlet nozzle comprises a steam outlet, a hot water outlet or a beverage dispensing nozzle.

12. The apparatus of claim 11, further comprising a lever which couples the valve member and the fluid outlet nozzle, the lever being operable to transition the valve member between first and second positions as the fluid outlet nozzle is moved between the stowed and operating positions.

13. The apparatus of claim 12, wherein the lever engages with a track on a fluid outlet nozzle mechanism.

14. The apparatus of claim 13, wherein fluid outlet nozzle mechanism comprises at least one member which is rotated about a rotational axis of the member when moving the fluid outlet nozzle from the stowed position to the deployed position and,
the track comprises at least one runner which is eccentrically arranged with respect to the rotational axis of the member such that rotating the member displaces the valve member from the first position to the second position or vice versa.

15. The apparatus of claim 14 wherein the at least one runner comprises a first runner configured to move the valve member from the first position to the second switch position, and a second runner configured to move the valve member from the second switch position to the first switch position.

16. The apparatus of claim 15, wherein the lever is moved between the first and second runners under the influence of the biasing member.

17. The apparatus of claim 1, further comprising a fluid source connected to the first fluid delivery line and, optionally, the second fluid delivery line.

18. The apparatus of claim 1, wherein the first fluid delivery line is connected to the fluid outlet nozzle and, optionally, wherein the second fluid delivery line is connected to the fluid outlet nozzle.

19. A bi-stable valve arrangement for shutting-off a first fluid delivery line and a second fluid delivery line, the valve arrangement comprising:
a rotating valve member movable between a first position in which a first fluid delivery line is open and a second fluid delivery line is shut-off, and a second position in which the first fluid delivery line is shut-off and the second fluid delivery line is open; and,
a biasing member configured to rotatably urge the valve member against the second delivery line when in the first position and the first delivery line when in the second position.

20. The valve arrangement of claim 19, wherein the valve member moves through a biasing threshold when moving from the first position to the second position and form the second position to the first position,
wherein the biasing member is configured to resist rotation of valve member when moving away from either of the first or second delivery lines and prior to moving through the biasing threshold, and, after passing through the biasing threshold, configured to rotatably urge the valve member away from the biasing threshold towards the other of the first or second fluid delivery lines.

21. The valve arrangement of claim 20, wherein the valve member comprises compression portions on opposing sides of the rotational axis of the valve member, the compression portions being configured to contact and compressing the first and second delivery lines in the respective first and second positions.

22. The valve of claim 19, wherein the valve member comprises a biasing point from which the biasing member urges the valve member into either the first or second positions, wherein the biasing point is radially offset from the rotational axis.

23. The valve arrangement of claim 22, wherein the biasing member extends between an anchor point located on a valve housing and the biasing point.

24. The valve arrangement of claim 23, wherein the rotation axis, biasing point and anchor point lie along a central axis when the valve member is provided in a central position between the first and second positions and the compression portions are provided on opposing sides of the rotational axis.

25. The valve arrangement of claim 19, wherein the biasing member is provided within a chamber, wherein one or more lateral walls of the chamber restrict the movement of the biasing member when in the first and second positions.
